(19) United States
(12) Patent Application Publication
(10) Pub. No.: US 2009/0168974 A1
(43) Pub. Date: Jul. 2, 2009

(54) VEHICLE EMERGENCY CALL HANDLING AND ROUTING TO PSAPS

(75) Inventor: Catherine L. Mc Cormick, West Bloomfield, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GENERAL MOTORS CORPORATION, Detroit, MI (US)

(21) Appl. No.: 11/964,150

(22) Filed: Dec. 26, 2007

(51) Int. Cl. H04M 11/04

(52) U.S. Cl. 379/45

(57) ABSTRACT

A method of facilitating emergency calls from a vehicle includes receiving a call, transmitting data from a vehicle telematics unit to a call center, obtaining the location of the vehicle at the call center, determining at the call center that emergency help is needed, accessing an emergency routing database and, using the vehicle location, determining a preferred public safety answering point (PSAP), obtaining from the emergency routing database emergency contact information associated with the preferred PSAP, and establishing a three-way conference call between the call center, the vehicle telematics unit, and the preferred PSAP utilizing voice over internet protocol (VoIP). Data such as vehicle location can be transmitted to the PSAP electronically during the forwarded call.

### TECHNICAL FIELD

The present invention relates generally to wireless telephony and vehicles. More specifically, the present invention relates to facilitating emergency calls from a vehicle to a PSAP using VoIP.

### BACKGROUND OF THE INVENTION

Voice over Internet Protocol (VoIP) is a protocol optimized for the transmission of voice through the Internet or other packet switched networks. VoIP systems carry voice signals as compressed digital audio, reduced in data rate using speech compression techniques. The system then sends the compressed digital audio as packetized data over a data packet stream over IP. Increasingly, telephony consumers are substituting traditional publicly switched telephone network service for VoIP service. However, this switch has not come without problems. Traditional PTSN customers enjoy reliable enhanced 911 services identifying a user's location to a Public Service Access Point (PSAP) during an emergency while VoIP customers could call 911, but may have to verbally convey their location to the 911 operator. Presently, VoIP service providers have implemented an enhanced VoIP system that asks customers to provide locations associated with a phone number when registering for service. When a VoIP customer calls 911, the enhanced VoIP 911 system finds a PSAP located near the customer's given location. But the enhanced VoIP 911 system relies on the accuracy of customer data for effectiveness. If the user has provided even subtly incorrect information it could lead to increases in emergency response time and wasted emergency service resources.

Increasingly, vehicle manufacturers outfit their vehicles with a wide array of wireless communications capabilities. Telematics devices installed in modern vehicles can wirelessly send both voice and data communications to a variety of recipients. Recipients can be central facilities that include servers and/or live advisors capable of meeting an owner's needs. Additionally, vehicles have the ability to gather a diverse array of data about vehicle status and send it via the telematics device. However, during emergencies, telematics subscribers often connect with an administrative number and not the main 911 trunk lines, curtailing the usefulness of vehicle data. And the telematics device may be limited to sending data to the call center during an emergency, which may limit its usefulness.

### SUMMARY OF THE INVENTION

According to an aspect of the invention, a method of facilitating emergency calls from a vehicle includes initiating an emergency call, transmitting vehicle data during the emergency call, locating an appropriate public safety access point (PSAP) based on the vehicle data, forwarding the emergency call and the vehicle data to the appropriate PSAP using voice over internet protocol (VoIP), and providing vehicle information electronically to the PSAP concurrently with the emergency call. The vehicle information can be some or all of the vehicle data, or can be derived from the vehicle data, or can be other vehicle-related information.

According to another aspect of the invention, a method of facilitating emergency calls from a vehicle includes establishing an emergency call, transmitting vehicle data to a call center during the emergency call, obtaining the location of the vehicle, determining at the call center to connect the emergency call to a public safety access point (PSAP), accessing PSAP locations from a database, comparing the location of the vehicle to the PSAP locations, identifying a PSAP located nearest the vehicle, providing a communications conduit between a vehicle telematics unit and the identified PSAP using voice over internet protocol (VoIP), and transmitting the vehicle data to the identified PSAP.

According to another aspect of the invention, a method of facilitating emergency calls from a vehicle includes receiving a call, transmitting data from a vehicle telematics unit to a call center, obtaining the location of the vehicle at the call center, determining at the call center that emergency help is needed, accessing an emergency routing database and, using the vehicle location, determining a preferred public safety answering point (PSAP), obtaining from the emergency routing database emergency contact information associated with the preferred PSAP, and establishing a three-way conference call between the call center, the vehicle telematics unit, and the preferred PSAP, wherein the call utilizes voice over internet protocol (VoIP).

### BRIEF DESCRIPTION OF THE DRAWINGS

One or more preferred exemplary embodiments of the invention will hereinafter be described in conjunction with the appended drawings, wherein like designations denote like elements, and wherein:

FIG. 1 is a block diagram depicting an exemplary embodiment of a communications system that is capable of utilizing the method disclosed herein;

FIG. 2 is a flow chart depicting an exemplary embodiment of a method for facilitating emergency calls from a vehicle;

FIG. 3 is a flow chart depicting a call flow using an exemplary method for facilitating emergency calls from a vehicle.

### DETAILED DESCRIPTION OF THE PREFERRED EMBODIMENT(S)

The method of facilitating emergency calls described below generally attempts to provide vehicle information associated with an emergency call originating at a vehicle to a PSAP using VoIP. The method envisions a telematics user who believes he needs emergency help placing an emergency call. When the user places an emergency call, the call can be received at a call center. The call center can also receive vehicle information accompanying the call, such as vehicle position generated by an on-board Global Positioning System (GPS) receiver. The call center can then determine the extent of the emergency and decide whether the call warrants forwarding to a PSAP. If the call center determines that the call should be forwarded to the PSAP, it can use the vehicle position to determine the PSAP nearest the vehicle and forward the call there via VoIP. At this time, the call center can monitor the emergency as a third party or simply hand off the caller to the PSAP. Either way, the vehicle data generated by the telematics device can continue to be transmitted to the PSAP giving the emergency service provider real time vehicle data, such as location, direction of travel, and speed of the vehicle. The packetized data transmission can aid the vehicle in providing a wealth of data to the PSAP helping response time and shaping the services the PSAP determines necessary. Transmitting vehicle data to a PSAP also permits emergency service providers to follow and help an emergency situation as it moves. Vehicle data received at the PSAP can be organized into an electronic map. As the vehicle moves in a particular area, the user can graphically depict the vehicle's movement relative to the surrounding areas. An electronic map can also help PSAP personnel appreciate the vehicle's movement relative to other emergency service vehicles.

Public service access point (PSAP) generally refers to an agency responsible for handling 911 calls for emergency assistance from police, fire, or ambulance services. Over 8,000 PSAPs exist in the US and each is responsible for handling emergency calls in a particular Emergency Service Zone. An emergency service zone (ESZ) is a geographic zone associated with a unique PSAP. The ESZ enables the routing of emergency calls to the PSAP responsible for the caller's area. The ESZ can be the range of latitude and longitude coordinates that define the boundaries of a particular ESZ. Each PSAP and its corresponding ESZ can then be stored in a Telematics PSAP database. The PSAP can also be linked to an Automatic Location Identification (ALI) database. This ALI database relates a specific telephone number to a location or address. The ALI can accept a PSAP query with a telephone number and respond with an address or location.

VoIP enables a user to place telephone calls much like a Publicly Switched Telephone Network (PSTN). But unlike a PSTN using a circuit-switched system, VoIP can send voice calls as packetized data over the Internet. A traditional telephone handset can use an analog telephone adapter that converts a call to a digital audio signal. Protocols carrying telephony signals as digital audio signals can be encapsulated in a data packet stream over IP and typically reduced in data rate using speech data compression techniques. Many different protocols are used depending on the service provider. One common VoIP protocol is Session Initiation Protocol. Session Initiation Protocol (SIP) is an application-layer control protocol for creating, modifying, and terminating sessions with one or more participants. It can be used to create two-party or multiparty sessions that include Internet telephone calls, multimedia distribution, and multimedia conferences. Other VoIP protocols can be used as well, such as H.323. While VoIP service can manifest itself in many forms, generally most forms of VoIP service use an enhanced 911 service that attempts to provide information similar to that available to PSTN customers and can be generally referred to as VoIP enhanced 911.

Like VoIP itself, VoIP enhanced 911 can be implemented in a variety of ways. For instance, VoIP enhanced 911 service can begin by placing an emergency call. The emergency call can then be received at a media gateway or VoIP call server which then determines that the call is of an emergency nature and accesses a VoIP Positioning Center (VPC). A VPC can be an application that determines an appropriate PSAP based on the caller's location and returns routing instructions to the VoIP network by providing the caller's location and callback number through the ALI. The VPC may also use an Emergency Resource Database (ERDB) containing available PSAPs and their ESZs. The VPC receives information regarding an incoming call and determines the appropriate PSAP to handle the call based on the caller's location. Alternatively, the caller's location may be determined using a Location Information server (LIS). The LIS can be responsible for storing and providing access to the caller's location information. Ultimately, once the VPC determines the appropriate PSAP, the caller's location and call back number (CBN) can be forwarded to that PSAP. The VPC can send this information using an Emergency Services Query Key, an Emergency Services Routing Number, and a Last Routing Option. First, an Emergency Services Query Key (ESQK) is a digital string that uniquely identifies an ongoing emergency services call (e.g, with a CBN and unique ID) or can identify an ESZ associated with an emergency call and be used to route a call through the network. Second, the Emergency Services Routing Number (ESRN) is a 10-digit number that specifies the selective router to be used to route a call. And lastly, a Last Routing Option (LRO) is routing information sent by a VPC that provides a “last chance” destination for a call, such as a contingency routing number associated with a national call center. Using the aforementioned routing information, the VoIP network can then use an Emergency Services Gateway to direct the emergency call to the appropriate router which, in turn, directs the call to the appropriate PSAP. After receiving the caller's location and call back number, the PSAP can render assistance.

### Communications System—

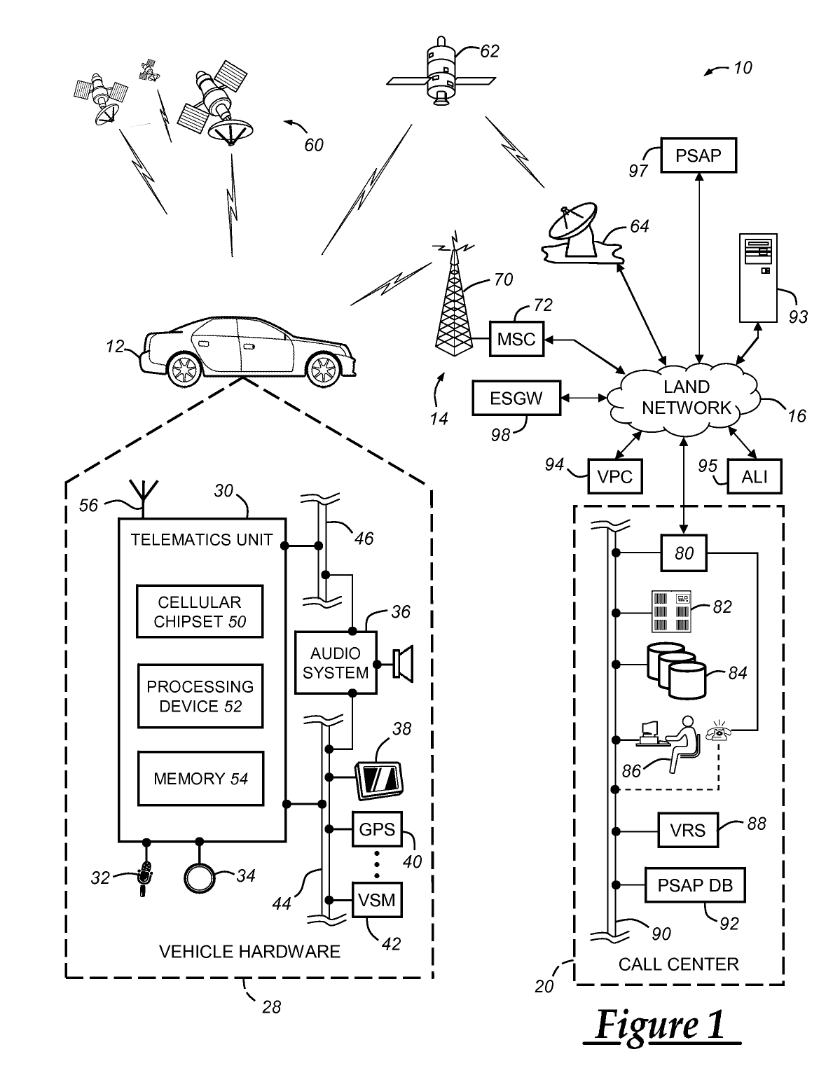

With reference to FIG. 1, there is shown an exemplary operating environment that comprises a mobile vehicle communications system 10 and that can be used to implement the method disclosed herein. Communications system 10 generally includes a vehicle 12, one or more wireless carrier systems 14, a land communications network 16, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such exemplary system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 preferably enables wireless voice and/or data communication over wireless carrier system 14 so that the vehicle can communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, EDGE, and WiMAX.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system for other purposes, such as fleet management. Also, new or updated map data can be downloaded to the GPS module 40 from the call center 20 via the telematics unit 30.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a PSTN such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Call center 20 can also include a telematics PSAP database 92 containing the ESZ and other contact information for each PSAP. This can be a separate database or one integrated into database 84. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

The system 10 of FIG. 1 additionally includes various other components that can be used to carry out emergency call handling and routing using VoIP. In particular, system 10 can include a media server and integrated VoIP call server 93, a VoIP positioning center (VPC) 94, an automatic location identification database (ALI) 95, an emergency services gateway (ESGW) 98, as well as a number of PSAPs 97 (only one shown). The ESGW 98 is part of an existing VoIP to PSAP infrastructure that connects VoIP calls to PSAPs. The implementation of these components and their integration into the system 10 will be known to those skilled in the art. In this regard, although these components are each shown as separately being connected to land network 16, it will be appreciated by those skilled in the art that one or more of these components can be connected to the system via a different communications link, such as via wireless network 14. Also, two or more of these components can be integrated together or can be integrated into other portions of system 10, such as with call center 20. As will be described below, using these components as well as others from system 10, emergency calls from a vehicle 12 to the call center 20 can be screened to confirm that an emergency exists and various vehicle data including location can be obtained, used to determine the preferred PSAP 97, with that PSAP then being conferenced into the call and appropriate vehicle data received by the call center can be electronically transmitted to the PSAP during the call for use in improving emergency response.

### Method—

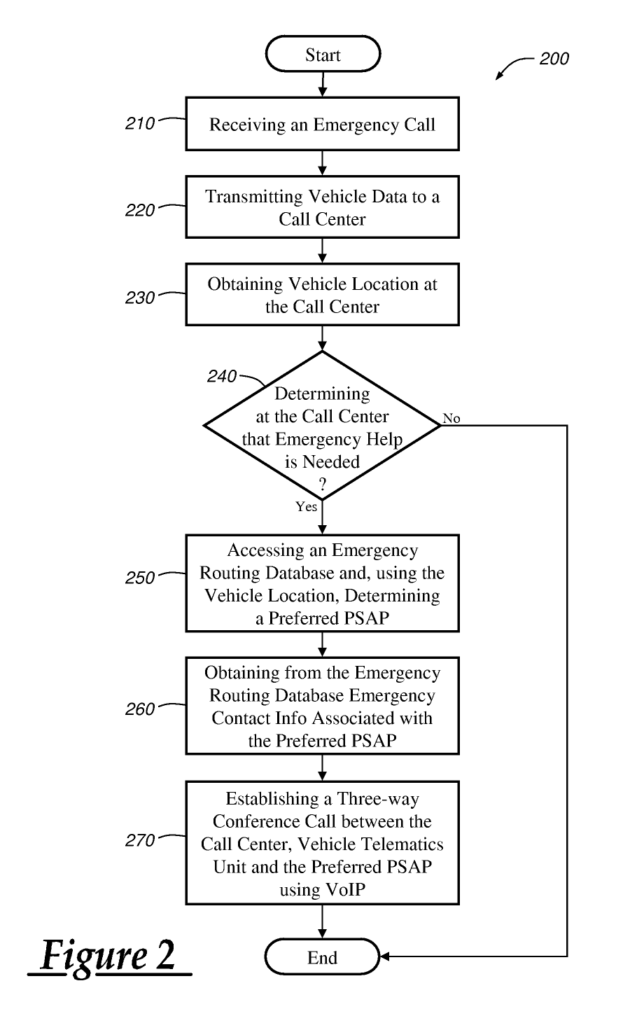

Turning now to FIG. 2, the present communications method can be used to facilitate emergency messages from a vehicle.

The method 200 begins at step 210 where an emergency call is received. Generally, a vehicle occupant can place a call using a telematics unit 30 to a call center 20 indicating that the occupant believes an emergency exists. This call may be initiated by pushing a button located in the vehicle that accesses stored contact information, or by dialing digits manually. The emergency call can then be received at a call center 20 or any other central facility. The method 200 then progresses to step 220.

At step 220, vehicle data is transmitted to a call center. Vehicle data can describe a wide array of parameters that relate to vehicle operation. For instance, the telematics unit 30 can receive information from vehicle sensors that indicate such things as vehicle direction, vehicle velocity, and vehicle location from the GPS navigation module 40. Other examples of vehicle data can include the status of vehicle systems such as oil temperature, coolant temperature, tire pressure, airbag deployment, activation of stability control, or ignition key position. This data can be wirelessly communicated to a call center 20 or directly to a PSAP either at the behest of a vehicle occupant or a live/automated advisor or a PSAP. The vehicle data can then be sent via the wireless carrier system 14. Vehicle data can be packetized and sent via any of the protocols presently in use or described herein. At this point the method 200 then proceeds to step 230.

At step 230, the location of a vehicle is received at the call center. Vehicle location can be determined from latitude and longitude coordinates generated by the GPS navigation module 40. Coordinates can be generated in a multitude of ways. For instance, vehicle coordinates can be produced constantly as live streaming data or at fixed intervals depending on the application. It is also envisioned that vehicle location can be generated. The method 200 can then proceed to step 240.

At step 240, the call center determines whether emergency help is needed. The call center 20 may determine whether emergency help is needed using an automated advisor 88, a live advisor 86, or simply by recognizing that the vehicle occupant has dialed an emergency-only number. A live advisor 86 can interact with the vehicle occupant, asking questions and discerning the severity of the emergency situation. For instance, a live advisor 86 can determine whether a) the vehicle occupant requires emergency assistance; and b) if the vehicle occupant does require assistance what type of assistance that can best help the occupant. For example, if a vehicle occupant calls for emergency assistance and says that there has been a vehicle accident and that they require medical assistance, the live advisor 86 can confirm that the vehicle 12 has been in an accident using a collision sensor interface module (and determine) the airbags deployed and send an ambulance. Or if the live advisor 86 receives an emergency call, the advisor may determine that the event does not need emergency services and can prevent the unnecessary deployment of emergency personnel, thereby saving resources. An automated advisor 88 on the other hand can use scripted audio questions and speech recognition technology to ask what kind of services the occupant seeks. The method 200 can then proceed to step 250.

At step 250, an emergency routing database is accessed and using the vehicle location a preferred PSAP is determined. Upon receiving the emergency call from the telematics unit 30, the call center 20 can access a telematics PSAP database 92 that contains all of the available PSAPs and their corresponding ESZs. Alternatively, the call center can access the ESDB described above. The telematics PSAP database 92 can be used interchangeably with the ERDB discussed above. But, while both the telematics PSAP database 92 and the ERDB each contain similar information, they can be maintained by different entities, the telematics service provider and the VoIP service provider respectively. Using the previously determined vehicle location, the call center 20 can search the telematics PSAP database 92 and cross-reference the vehicle location with PSAP ESZs to determine a preferred PSAP. For instance, the call center 20 can obtain a match when the telematics unit 20 location is found to be within an ESZ boundary linked to a PSAP. The matched PSAP is likely able to render assistance to the vehicle occupant and can be considered a preferred PSAP. At this time, the method 200 can proceed to step 260.

At step 260, contact info associated with the preferred PSAP is obtained from the emergency routing database. As discussed above, the telematics PSAP database 92 contains all available PSAPs and their associated ESZs. The telematics PSAP database 92 can also contain contact information and routing information for each PSAP. Not only can the telematics PSAP database 92 contain an administrative contact number for contacting the PSAP, but the database 92 also contains routing information that can direct the emergency call to the main 911 trunk line of the preferred PSAP. The method 200 then proceeds to step 270.

At step 270, a three-way conference call is established utilizing VoIP between the call center, the vehicle telematics unit and the preferred PSAP. Once the preferred PSAP has been identified, the call center 20 can monitor the emergency call between the vehicle occupant and the PSAP. Monitoring the call allows the call center 20 to provide any background information or additional data that may be helpful to reduce emergency response time. Additionally, vehicle data can simultaneously be sent to the PSAP. This data can be sent as packetized data over the VoIP network from the telematics unit 30 to the call center 20 and then to the preferred PSAP. Alternatively, the telematics unit 30 can send the data directly to the preferred PSAP via the VoIP network. One example where a three-way conference call can be helpful is during Amber Alerts issued when a child is missing. For instance, if a caller follows a suspect, the telematics unit 20 can provide vehicle data such as speed and vehicle direction in real time or in snapshots. This helps PSAP direct police and aid in apprehending criminals. In addition, the call center 20 can provide the preferred PSAP with background information such as where the vehicle has traveled in the time leading up to the emergency call. Or, if the PSAP cannot receive the vehicle data, the call center 20 can verbally inform the PSAP about any helpful background information or vehicle data.

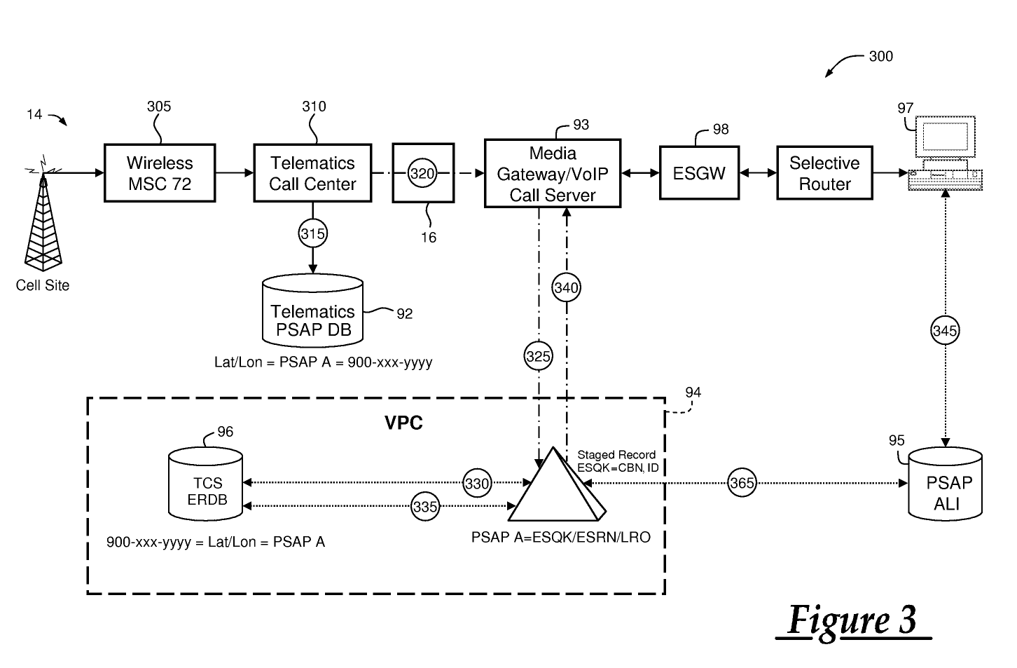

Turning now to FIG. 3, another embodiment of the present communications method can be used to facilitate emergency messages from a vehicle. As will be appreciated by those skilled in the art, the additional

The method 300 begins at step 305 where the telematics device 30 can initiate an emergency call to a wireless carrier system 14. The call is processed at a mobile switching center 72 within the land network 16. The method 300 then proceeds to step 310.

At step 310, an emergency call is routed through the mobile switching center 72 to the call center 20. The call can carry vehicle data, such as location data or data indicating a vehicle accident. Using this data, live advisor 86 at the call center 20 can determine whether emergency help is required. The method then proceeds to step 315.

At step 315, if emergency help is needed, the live advisor 86 at a call center 20 queries the local PSAP database (ERDB) 92 using the latitude and longitude location of the caller and determines which PSAP 97 should receive the emergency call. The PSAP database 92 can provide the preferred PSAP 97 (e.g., the PSAP having jurisdiction for ESZ within which the vehicle is located) along with a ten-digit phone number associated with the preferred PSAP 97. The method 300 then proceeds to step 320.

At step 320, the live advisor 86 establishes a three-way conference call by dialing the ten-digit number. The call can pass via the land network 16 to a suitable VoIP network. This can be done using a media gateway/VoIP call server 93, the implementation and use of which is known to those skilled in the art. At step 325, the VoIP call server 93 receives the call and determines that the call is of an emergency nature. This determination can be done based on the dialed digits. The VoIP network then can forward the ten-digit number to a VPC 94 for routing instructions. The method 300 then proceeds to step 330.

At step 330, the VPC 94 queries the ERDB 96 to determine the proper PSAP based on the forwarded ten digit number. The VPC 94 can then assign an ESQK designated for the preferred PSAP and stage a record containing the ESQK and the call back number of the call center 20. The method 300 the proceeds to step 335.

At step 335, the VPC responds to the request for routing instructions with the ESQK, an ESRN, and a LRO. Then, at step 340, the VoIP call server 93 uses the ESRN to determine the appropriate Emergency Services Gateway (ESGW) 98 and routes the call appropriately. The ESGW 98 can be responsible for integrating the SIP network and routing calls to an appropriate router based on a ESRN or ESQK it receives. The ESGW 98 then can convert the VoIP call to time-division multiplexing and uses the ESQK to route the call to the preferred PSAP 97. The method 300 then proceeds to step 345.

At step 345, the preferred PSAP 97 receives the call containing the ESQK and queries an ALI 95 with the ESQK. The ALI 95 steers the query to the correct VPC as directed to by the ESQK. The VPC can then respond to the ALI with a staged ALI record for the particular ESQK. The ALI can then forward the vehicle data (location, etc.) to the PSAP 97.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method of facilitating emergency calls from a vehicle, the steps comprising:
(a) initiating an emergency call;
(b) transmitting vehicle data during the emergency call;
(c) locating an appropriate public safety access point PSAP based on the vehicle data;
(d) forwarding the emergency call to the PSAP using voice over internet protocol (VoIP); and
(e) providing vehicle information electronically to the PSAP concurrently with the emergency call.

2. The method of claim 1, wherein the vehicle data of step (b) is chosen from the group consisting of: vehicle location, vehicle direction, vehicle speed, or collision data.

3. The method of claim 1, wherein the vehicle information provided to the PSAP in step (e) is based on at least some of the vehicle data.

4. The method of claim 1, wherein step (c) further comprises locating the appropriate PSAP using a PSAP database at a call center containing available PSAPs.

5. The method of claim 4, wherein step (c) further comprises determining the location of the vehicle using the vehicle data and comparing the location to emergency service zones associated with available PSAPs in the PSAP database.

6. The method of claim 1, wherein step (d) further comprises establishing a three-way conference call between a call center, a vehicle telematics unit, and the PSAP, wherein the call utilizes voice over internet protocol (VoIP).

7. The method of claim 1, wherein step (d) further comprises using either a live advisor or an automated advisor at a call center to respond to emergency calls.

8. The method of claim 1, wherein step (c) further comprises determining vehicle location and step (e) further comprises the steps of providing the vehicle location from a VoIP processing center to an automatic location identification (ALI) database and transmitting the vehicle location from the ALI database to the PSAP concurrently with the emergency call.

9. A method of facilitating emergency calls from a vehicle, the steps comprising:
(a) establishing an emergency call;
(b) transmitting vehicle data to a call center during the emergency call;
(c) obtaining the location of the vehicle;
(d) determining at the call center to connect the emergency call to a public safety access point (PSAP);
(e) accessing PSAP locations from a database;
(f) comparing the location of the vehicle to the PSAP locations;
(g) identifying a PSAP located nearest the vehicle;
(h) providing a communications conduit between a vehicle telematics unit and the identified PSAP via voice over internet protocol (VoIP); and
(i) transmitting the vehicle data to the identified PSAP.

10. The method of claim 9, wherein the vehicle data of step (b) is chosen from the group consisting of: vehicle location, vehicle direction, vehicle speed, or collision data.

11. The method of claim 9, wherein the vehicle data is vehicle location and wherein step (i) further comprises the steps of providing the vehicle location from a VoIP processing center to an automatic location identification (ALI) database and transmitting the vehicle location from the ALI database to the identified PSAP concurrently with the emergency call.

12. The method of claim 9, wherein step (d) further comprises using either a live advisor or an automated advisor at the call center to respond to emergency calls.

13. The method of claim 9, wherein step (f) further comprises comparing the location of the vehicle to an emergency service zone associated with each PSAP to determine if the location of the vehicle lies within the emergency services zone for a particular PSAP.

14. The method of claim 9, wherein step (i) further includes creating a map at a PSAP that tracks vehicle position based on the location of the vehicle.

15. The method of claim 9, wherein step (h) further includes establishing a three-way conference call between a call center, a vehicle telematics unit, and a PSAP, wherein the call utilizes voice over internet protocol (VoIP).

16. A method of facilitating emergency calls from a vehicle, the steps comprising:
(a) receiving a call from a vehicle at a call center;
(b) transmitting data from a telematics unit in the vehicle to the call center;
(c) obtaining the location of the vehicle at the call center;
(d) determining at the call center that emergency help is needed;
(e) accessing an emergency routing database and, using the vehicle location, determining a preferred public safety answering point (PSAP);
(f) obtaining from the emergency routing database emergency contact information associated with the preferred PSAP; and
(g) establishing a three-way conference call between the call center, the vehicle telematics unit, and the preferred PSAP, wherein the call utilizes voice over internet protocol (VoIP).

17. The method of claim 16, wherein the data of step (b) is chosen from the group consisting of: vehicle location, vehicle direction, vehicle speed, or collision data.

18. The method of claim 16, wherein step (d) further comprises using either a live advisor or an automated advisor at a call center to respond to emergency calls.

19. The method of claim 16, wherein step (e) further comprises determining the location of a vehicle and comparing the location to an emergency service zone associated with each PSAP to determine if the location of the vehicle lies within the emergency services zone.
